(19) United States
(12) Patent Application Publication
(10) Pub. No.: US 2008/0285767 A1
(43) Pub. Date: Nov. 20, 2008

(54) Method for the Estimation of a Useful Signal with the Aid of an Adaptive Process

(76) Inventor: Harry Bachmann, Stafa (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/091,547

(22) PCT Filed: Oct. 25, 2006
(86) PCT No.: PCT/EP2006/067770

§ 371 Date: Apr. 25, 2008

(30) Foreign Application Priority Data
Oct. 25, 2005 (CH) 01710/05

(51) Int. Cl. G10K 11/16

(52) U.S. Cl. 381/71.1

(57) ABSTRACT

Disclosed is an active noise detection system which is used in a room and utilizes at least one sensor unit for detecting the residual cumulative signal (e+g), one of the sensor units being used for detecting a useful signal (g). In order to make said useful signal (g) available at an improved quality, an additional adaptive process unit (11) is provided which controls another filter unit (10) so as to eliminate the residual signal (e) from the previously detected cumulative signal (e+g), thus making it possible to obtain the useful signal (g) that largely corresponds to the effective useful signal.

### RELATED APPLICATION

This application is the U.S. national phase application under 35 U.S.C.§371 of International Application No. PCT/EP2006/067770 filed Oct. 25, 2006 which claims priority of Switzerland Application No. 01710/05 filed Oct. 25, 2005.

### TECHNICAL FIELD

The present invention relates to a method and a device for estimating a desired signal contained in a room with the aid of an adaptive noise reduction system, a noise signal (x), that is at leastly partly emitted outside of the room, being superimposed on the desired signal (g).

### BACKGROUND AND SUMMARY

The principle of the invention depicted in this description is given on the basis of a system for active noise reduction the processor unit, depicting this system.

Sources of noise are increasingly perceived as environmental pollution and are regarded as reduction of life quality. Because sources of noise often cannot be avoided, methods to reduce noises have already been proposed, which are based on the principle of wave cancelling.

The principle of active noise reduction (ANC) is based on the cancelling of sound waves by interferences. These interferences are generated by one or several electro-acoustic converters, for example by loudspeakers. The signal emitted by the electro-acoustic converters is calculated on the basis of a suitable algorithm and is corrected on a regular basis. As basis for the calculation of the signal emitted by the electro-acoustic converters, information is used that is provided by one or several sensors. This is, on the one hand, information on the composition of the signal to be minimized. Thereto, a microphone, for example, can be used that records the sound to be minimized. On the other hand, also information is necessary on the remaining residual signal. Microphones can also be used thereto.

The basic principle implemented for active noise reduction has been described by Dr. Paul Lueg in a patent specification going back to the year 1935 having a publication no. AT-141 998 B. This printed publication discloses how noise can be cancelled in a tube by generating a signal having opposite phase.

An algorithm for active noise reduction needs information of at least one sensor (for example a microphone), which determines the residual error—in the following also called error signal. Dependent on implementation and implemented algorithm, a further sensor is provided that provides information on the composition of the signal to be minimized. Furthermore, an adaptive noise reduction system needs one or several actuators (for example in the manner of loudspeakers) in order to output the correcting signal. The information of the sensors must be converted in a corresponding format by an analog-to-digital converter. The signal is reconverted by a digital-to-analog converter after processing by the algorithm, and transmitted to the actuators.

In many situations, where noises with the aid of wave cancelling should be reduced, detecting of additional information is necessary—like a voice signal for example—these must not be in connection with the computation carried out by the adaptive processor unit.

Conventional procedures provide the use of additional suitable sensors, as a microphone, for example, in case the additional signal is speech a signal regeneration being necessary. In this case, a microphone would not only detect a voice signal g but also the residual signal e. Thus, in view of FIG. 1, an additional sensor unit would detect a signal e+g, which is composed from the voice signal g and the residual signal e. As the residual signal e is always present, it will also be detected together with the voice signal g (desired signal).

Thus, the object of the present invention is to provide a method for estimating desired signals, by which no additional sensor unit is necessary.

This object is resolved by determining an estimated residual signal (\tilde{e}) in a further adaptive process, in which the noise signal (x) is processed and subtracting the estimated residual signal (e) from the summation signal (e+g) in order to obtain an estimated desired signal (ĝ). Further embodiments of the present invention as well as a device are described hereinafter.

First of all, a method is given for estimating a desired signal contained in a room with the aid of an adaptive noise reduction system, a noise signal, that is at least partly emitted outside of the room, being superimposed on the desired signal. The method consists in
detecting the noise signal with the aid of at least one sensor unit,
detecting a summation signal in the room with the aid of at least one further sensor unit, the summation signal comprising the desired signal and a residual signal, and
estimating a transmission path of the room with the aid of an adaptive process, in which the summation signal and the noise signal are processed.

The method is further characterized by
determining an estimated residual signal in a further adaptive process, in which the noise signal is processed and
subtracting the estimated residual signal from the summation signal in order to obtain an estimated desired signal.

A further embodiment of the present invention consists in that the estimated desired signal is fed to the further adaptive process.

A further embodiment of the present invention consists in
feeding the summation signal to the further adaptive process,
generating an estimated output signal with the aid of the estimated transmission path of the room by using the noise signal and
generating the estimated residual signal by subtracting the estimated output signal from an output signal generated with the aid of the further adaptive process.

Another further embodiment of the present invention consists in that the noise signal is detected by at least one sensor unit arranged outside the room.

Further a device is provided for estimating a desired signal contained in a room with the aid of an adaptive noise reduction system, a noise signal, that is at least partly emitted outside the room, being superimposed on the desired signal, the device comprising:
at least one sensor unit for detecting the noise signal,
at least a further sensor unit for detecting a summation signal in the room, the summation signal comprising the desired signal and a residual signal, and
an adaptive process unit for determining a transfer function of a filter unit by minimizing the summation signal and by using the noise signal the transfer function being an estimation of the transmission path of the room.

The device is characterized by
a further adaptive process unit, to which the noise signal is fed to,
a further filter unit, to which the noise signal is fed to,
a subtraction unit, which is operatively connected to an output of the further filter unit and to which the summation signal is fed the first mentioned signal being subtracted from the second mentioned signal in order to get an estimated desired signal.

An embodiment of the present invention consists in that the estimated output signal is fed to the further adaptive process unit.

A further embodiment of the present invention consists in
feeding the summation signal to the further adaptive process unit,
providing a subtraction unit that the estimated output signal of the filter unit is subtract-able from an output signal of the further filter unit for generating an estimated residual signal.

Another further embodiment of the present invention consists in that at least a sensor unit is arranged for detecting the noise signal outside the room.

It is pointed out that the afore-mentioned embodiments can be combined to each other in arbitral manner as far as no contradictions occur by a combination.

In the following, the present invention is described in particular in connection with systems for active noise reduction, also other uses being conceivable by all means, where the adaptive processor unit processes signals, which are not acoustic by nature and also the desired signal is not acoustic by nature.

In the following, the present invention will be further described with the aid of exemplified embodiments by referring to drawings.

### BRIEF DESCRIPTION OF DRAWINGS

FIG. 1 a block diagram of a known active noise reduction system, in schematic representation,

FIG. 2 a block diagram of a first embodiment of the invention, again in schematic representation, and

FIG. 3 a block diagram of a second embodiment of the invention, also in schematic representation.

### DETAILED DESCRIPTION

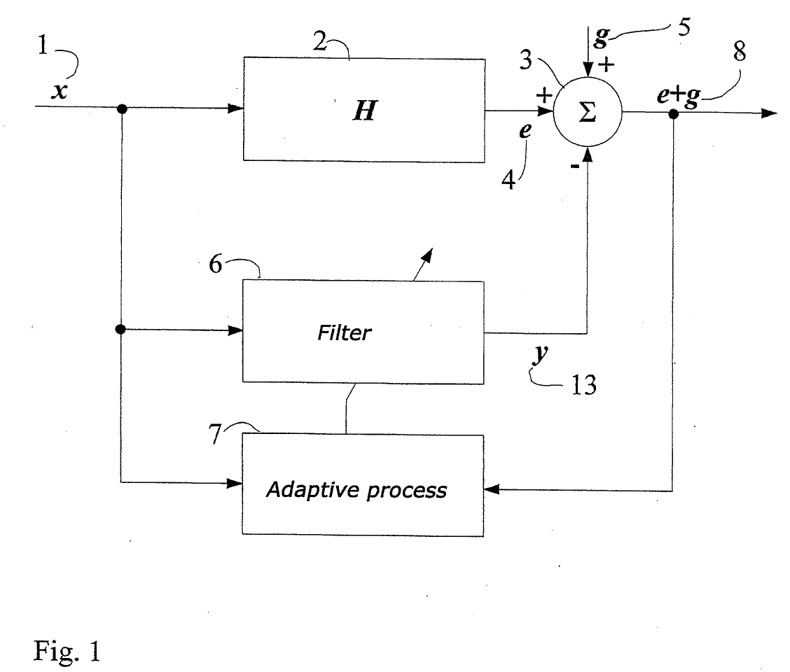

A known active noise reduction system is depicted in FIG. 1. The block diagram is an illustration of the actual circumstances, as it arises in detail from the explanations hereafter. A signal x to be minimized, which is detected with the aid of a sensor unit (a microphone for example) outside a room, is fed to a transmission path 2 characterized by a transfer function H. Therewith, expressing that the changed signal x is contained in the room in a certain frame, namely according to the transfer function H. Over an actuator unit (not depicted in FIG. 1) an estimated output signal y is fed to the room remaining a residual signal e, which is fed to an adaptive process unit 7. In the adaptive process unit 7 the filter unit 6 is adjusted such that over the estimated output signal y the residual signal e is minimized further on the basis of the residual signal e, eliminated completely at the best case. The mentioned signal concentrations are depicted by the addition unit 3 in FIG. 1, in which the estimated output signal y is subtracted from the residual signal e. Further, a desired signal g is added in the addition unit 3. At this, it is a matter of a voice signal of a person, for example, remaining in the room. As a rule, the desired signal g matters and should therefore not be eliminated by the noise reduction system. However, this is the case in the present configuration, because the signal e+g resulting by the summation from the adaptive process unit 7 is needed for changing the filter unit 6 continuously in order to reduce the remaining residual signal e at a regular basis. Therewith, the desired signal g is also eliminated or at least damped in a certain measure.

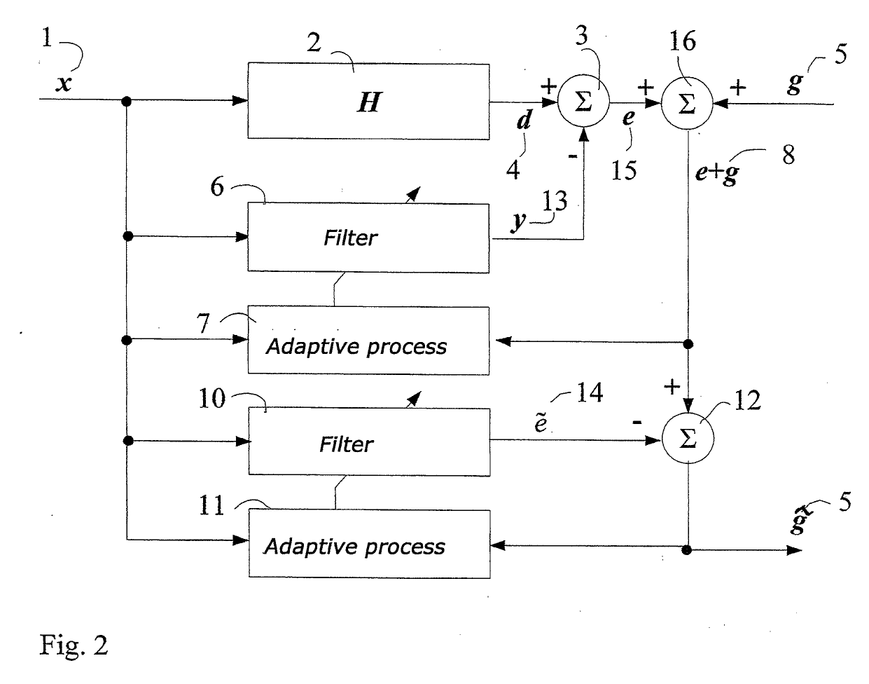

FIG. 2 shows a first embodiment of the invention on the basis of a block diagram. In order that the desired signal g is not eliminated like in the known method a further process unit 11 and a further filter unit 10 are provided. With the further units 10 and 11 an estimated residual signal e is generated, which corresponds as much as possible to the residual signal e. Therewith, the possibility according to the present invention is opened to gain the desired signal g. A generated input signal, namely the desired signal g, is fed to the adaptive process unit 11 by a further addition unit 12 and the signal x to be minimized. Herefrom, with the aid of an adaptive process, which is carried out in the adaptive process unit 11, the further filter unit 10 or its transfer function, respectively, is adjusted such that—by using a signal x to be minimized—the estimated residual signal \tilde{e} is obtained. The smaller the difference between the estimated residual signal \tilde{e} and the residual signal e is, the smaller is also the difference between the desired signal g and the determined desired signal ĝ.

The desired signal g, which can be speech in this case, for example, can be further processed for other uses, as for example in connection with a mobile phone in a car, where noises of engines and of rolling are actively minimized in the passenger cell.

The advantage of the application of the here presented invention in connection with the active noise reduction in the passenger cell of a car is such that no additional microphone must be used for the detection of voice signals.

A similar problem—also in connection with the active noise reduction—can arise if interpreters are employed. Interpreters typically are situated in cabins. The voice signal, which has to be translated, is detected typically outside the cabin by a microphone and is transmitted into the respective cabin, this transmission occurring wire-bound or via radio.

The microphone, which detects the voice signal, which has to be translated, detects typically not only the desired voice signal, but also noises of the environment. Possibly, these noises of the environment can be so loud that the isolation of the cabin is not sufficient in order to blank out these noises.

This entails for known systems (as for example also for a system according to FIG. 1) mainly two disadvantageous effects:
The work becomes more difficult for the interpreter because he cannot dedicate his concentration only to the voice signal to be translated, but in addition has to separate the voice signal from the noises of the environment as well.
The sound quality of the translated voice signal decreases, because the noise from the microphone penetrating into the interpreter cabin, which serves for the detection of the translated voice signal, is also detected.

A microphone for an interpreter cabin with actively minimized noises of the environment, which is applied for the detection of the residual signal e of the adaptive process unit, can also be applied for the detection of the voice signal (desired signal g).

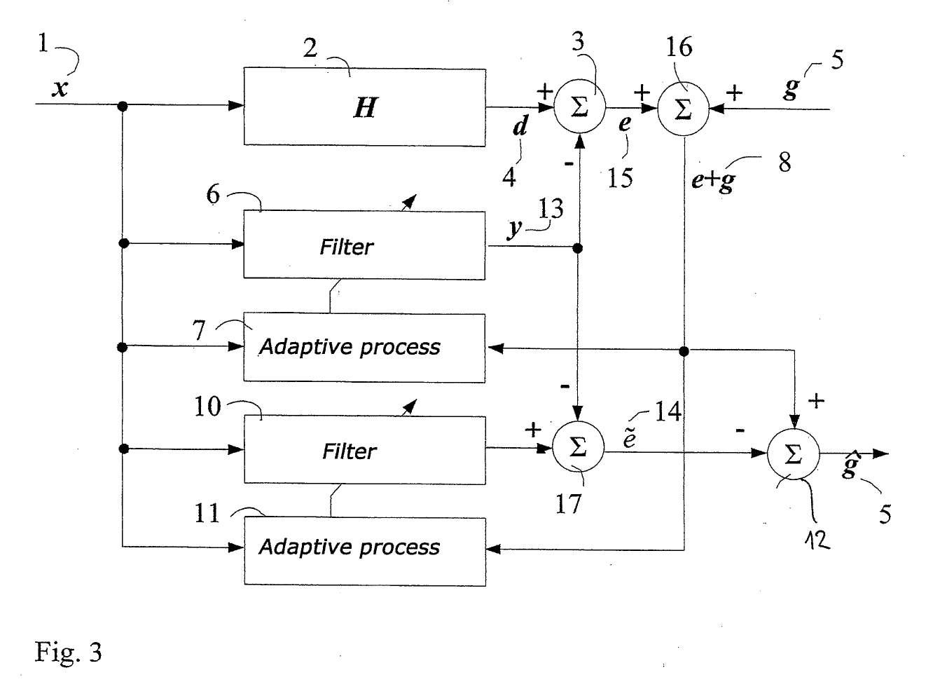

FIG. 3 shows another further embodiment of the present invention. As in the embodiment according to FIG. 2, a further filter unit 10 and a further adaptive process unit 11 are provided. In contrast to the embodiment according to FIG. 2, in the embodiment according to FIG. 3, not the desired signal g is fed to the further adaptive process unit 11 but the summation signal e+g detected in the room.

Further, not the estimated residual signal \tilde{e} is topped directly to the further filter unit 10, but a subtraction unit 17 is topped to the further filter unit 10, in which the estimated output signal of the further filter unit 10 is subtracted from the estimated output signal y in order to obtain the residual signal \tilde{e}. Herewith, the obtained estimated residual signal e is used in the following for the generation of the desired signal ĝ in the addition unit 12.

1. Method for estimating a desired signal (g) contained in a room with the aid of an adaptive noise reduction system, a noise signal (x), that is at least partly emitted outside of the room, being superimposed on the desired signal (g), the method comprising:
detecting the noise signal (x) with the aid of at least one sensor unit,
detecting a summation signal (e+g) in the room with the aid of at least one further sensor unit, the summation signal (e+g) including the desired signal (g) and a residual signal (e),
estimating a transmission path of the room with the aid of an adaptive process, in which the summation signal (e+g) and the noise signal (x) are processed,
determining an estimated residual signal (\tilde{e}) in a further adaptive process, in which the noise signal (x) is processed and
subtracting the estimated residual signal (\tilde{e}) from the summation signal (e+g) in order to obtain an estimated desired signal (ĝ).

2. Method according to claim 1, the estimated desired signal (ĝ) to the further adaptive process.

3. Method according to claim 1, further comprising
feeding the summation signal (e+g) to the further adaptive process,
generating an estimated output signal (y) with the aid of the estimated transmission path of the room by using a noise signal (x) and
generating the estimated residual signal (\tilde{e}) by subtracting the estimated output signal (y) from an output signal generated with the aid of the further adaptive process.

4. Method according to claim 1, including detecting a noise signal (x) by at least one sensor unit arranged outside the room.

5. Device for estimating a desired signal (g) contained in a room with the aid of an adaptive noise reduction system, a noise signal (x), that is at least partly emitted outside the room, being superimposed on the desired signal (g), the device comprising:
at least one sensor unit for detecting the noise signal (x),
at least a further sensor unit for detecting a summation signal (e+g) in the room, the summation signal (e+g) comprising the desired signal (g) and a residual signal (e),
an adaptive process unit (7) for determining a transfer function of a filter unit (6) by minimizing the summation signal (e+g) and by using the noise signal (x), the transfer function being an estimation of the transmission path of the room,
a further adaptive process unit (11), to which the noise signal (x) is fed,
a further filter unit (10), to which the noise signal (x) is fed,
a subtraction unit (12), which is operatively connected to the output of the further filter unit (10), and to which the summation signal (e+g) is fed the first mentioned signal being subtracted from the second mentioned signal in order to obtain an estimated desired signal ĝ)

6. Device according to claim 5, wherein the estimated desired signal (ĝ) is fed to the further adaptive process unit (11).

7. Device according to claim 5, further comprising
means for feeding the summation signal (e+g) to the further adaptive process unit (11),
a subtraction unit (17), in which an estimated output signal (y) of the filter unit (6) is subtracted from an output signal of the further filter unit (10) for generating the estimated residual signal (\tilde{e}).

8. Device according to claim 5, wherein the at least one sensor unit is arranged for detecting the noise signal (x) outside the room.
